(19) United States
(12) Patent Application Publication
(10) Pub. No.: US 2013/0065211 A1
(43) Pub. Date: Mar. 14, 2013

(54) Ultrasound Simulation Training System

(71) Applicants: Nazar Amso, Llandaff (GB); Nicholas Avis, Altrincham (GB); Nicholas Sleep, Whittlesford (GB)

(72) Inventors: Nazar Amso, Llandaff (GB); Nicholas Avis, Altrincham (GB); Nicholas Sleep, Whittlesford (GB)

(21) Appl. No.: 13/639,728

(22) PCT Filed: Apr. 8, 2011
(86) PCT No.: PCT/GB2011/050696

§ 371 Date: Oct. 5, 2012

(30) Foreign Application Priority Data
Apr. 9, 2010 (GB) 1005928.5

(51) Int. Cl. G09B 9/00

(52) U.S. Cl. CPC G09B 9/00
USPC 434/262

(57) ABSTRACT

The invention relates to a simulator training system for simulation training in ultrasound examination or ultrasound-guided procedures. The training system comprises a movable simulator input device to be operated by the user, and means for displaying an ultrasound scan view image which is an image or facsimile image of an ultrasound scan. The scan view image is variable and related to the position and/or orientation of the simulator input device. The system further includes means for displaying a second image, the second image being an anatomical graphical representation of a slice through of the body structure associated with the ultrasound scan view, the slice through displaying the scan beam plane of the simulator input device. The ultrasound scan view image and the second image are linked to vary in a coordinated manner as the position and/or orientation of the simulator input device changes.

### CROSS-REFERENCE TO RELATED APPLICATIONS

This application claims priority from PCT/GB/2011/050696 filed on Apr. 8, 2011 and from GB 1005928.5, filed Apr. 9, 2010, which are hereby incorporated by reference in their entireties.

### BACKGROUND OF THE INVENTION

1. Field of the Invention

The present invention relates generally to the field of medical training systems, and in particular to ultrasound training systems using ultrasound simulation.

2. State of the Art

Medical sonography is an ultrasound-based diagnostic medical technique wherein high frequency sound waves are transmitted through soft tissue and fluid in the body. As the waves are reflected differently by different densities of matter, their ‘echoes’ can be built up to produce a reflection signature. This allows an image to be created of the inside of the human body (such as internal organs) such that medical data can be obtained, thus facilitating a diagnosis of any potential medical condition.

In clinical practice, ultrasound scans are performed by highly trained practitioners who manipulate a transducer around, on or in a patient's body at various angles. In the case of trans-vaginal ultrasound, an internal probe is rotated or otherwise manipulated.

Medical and other health practitioners undergo extensive training programmes when learning how to use ultrasound machines appropriately and correctly. These programmes consist of in-classroom sessions, plus clinical training sessions during which the student observes an expert in the performance of an ultrasound scan. The student, by watching and copying, is taught how to identify and measure anatomical entities, and capture the data required for further medical examination or analysis.

In order to acquire the necessary skills, the ultrasonography student must develop a complex mix of cognitive skills and eye-hand movement coordination. Thus, the more practice a student gets at performing ultrasound operations, and the more anatomies (i.e. different patients) he/she experiences during the training the process, the better the student's skills are likely to be.

However, this is a lengthy and time consuming process, as well as being resource intensive. The present shortage of ultrasound-trained radiographers and the additional introduction of ultrasound techniques in many specialities such as obstetrics and gynaecology, cardiology, urology and emergency medicine have placed considerable pressure on the limited number of qualified trainers. The constant demand to meet health service delivery targets adds to the pressure. The essential challenge of ultrasound training therefore lies in resolving the conflict by expediting the acquisition of skills and increasing trainees' competency prior to hands-on patient contact. Thus, there is a need for an ultrasound training solution which provides an effective and reproducible training programme without the use of clinical equipment and/or expert supervision and leads to the reduction of time required to competency. In addition, this solution should be cost effective whilst reducing current pressures on resources and time. Ideally, such a solution would be capable of incorporating anatomies and pathologies not often seen in the learning environment, thus improving the quality and breadth of ultrasound training prior to students' exposure to live patients.

### SUMMARY OF THE INVENTION

Thus, in accordance with a first aspect of the present invention, there is provided a simulator training system for simulation training in ultrasound examination or ultrasound-guided procedures, the training system comprising:
a simulator input device to be operated by the user, the input device being movable;
means for displaying an ultrasound scan view image, being an image or facsimile image of an ultrasound scan, the scan view image being variable and related to the position and/or orientation of the simulator input device;
wherein:
a) the system further includes means for displaying a second image, the second image being an anatomical graphical representation of the body structure associated with the ultrasound scan view, wherein the ultrasound scan view image and the second image are linked to vary in a coordinated manner as the position and/or orientation of the simulator input device changes; and/or,
b) the system further includes means for electronically recording aspects of the users interaction with the system enabling an assessment or measure of the users performance to be made; and/or
c) the ultrasound scan view image is a composite image composed of scan view image data obtained from different sources and merged; and/or,
d) the ultrasound scan view image is generated from a scan volume, the scan volume being a 3-Dimensional (3-D) scan volume created by converting 2-Dimensional ultrasound scans or images to form the 3-Dimensional scan volume.

In a preferred realisation of the invention the system will include two or more of features a) b) c) and d).

The user (i.e. student or trainee or a trained professional undertaking a continued professional activity) may manipulate, re-orientate or otherwise move the simulator input device. Preferably, the simulator input device is configured to provide force feedback via the device to the user relating to the position and/or orientation and/or degree of force applied to the device by the user. It is preferred that data pertaining to the force applied to the control device is fed back to the student to enhance the realism of the student's experience. This feedback may be provided via the control device itself. The simulator input device may be a “replica intelligent” probe simulating that of a conventional ultrasound machine. The probe may be an intelligent probe such as a haptic device. However, other types of control device may be used.

The simulator may be called a ‘virtual ultrasound machine’. Preferably, the simulator is configured to present a visualisation which resembles at least partially the features and visualisation which would be presented by a clinical ultrasound machine. This is the ultrasound scan view image. The scan view image may be a mosaic produced using data obtained from a variety of sources such as patient scans. The patient scans may be 2-dimensional images obtained by scanning a patient's body using a clinical ultrasound device.

Preferably, the ultrasound simulation includes a scanned image of part of a patient's body, the view of the image being changeable in response to movement or manipulation of the simulator input device. Thus, the simulator coordinates and controls the perspective of the scanned anatomy as viewed by the user. In addition, the simulator system may provide a representation of at least one other ultrasound machine feature. For example, it may provide brightness and contrast controls.

It is preferred that the simulator input device corresponds or is mirrored by a ‘virtual’ ultrasound device which simulates the movement, orientation and/or position of the simulator input device.

Thus movement of the physical simulator input device causes a corresponding movement of the virtual ultrasound device. By manipulating the physical input control device, a user is able to alter the view or perspective of an image of an anatomy displayed via the system. This enables a user undergoing an assessment or practice session to perform virtual (i.e. simulated) scan-related tasks by manipulating the physical simulator input device. As the user moves the simulator input device, he/she is able to observe the virtual change effected by that movement. It is preferred that data pertaining to the movement of the control device is recorded or noted during the user's interaction with the system. This data may relate to the position, orientation, applied force and/or movement of the control device.

It is preferred that the movement or scan plane of the virtual device and anatomy are presented to the student for viewing of the scan view image in real time, preferably on a computer screen or, for example, as a holographic display. Preferably, this presentation resembles or mimics the scan view image which would be presented to the user of a ‘real’ ultrasound machine, thus providing a simulated yet realistic experience for the student.

In one preferred embodiment, a corresponding graphical representation of the scanned anatomy is provided in addition to the ultrasound scan view image. This second, graphical anatomical image is linked to the scan view image in a coordinated manner. The graphical anatomical representation of the anatomy may show the virtual control device or the scan plane and a ‘slice through’ of the anatomy based on the position of the simulator input device. As the user moves the physical simulator input device, the virtual control device shown in the representation mirrors that movement and the plane of the slice through the anatomy, is adjusted accordingly.

In those embodiments wherein both the ultrasound scan view image and graphical representation are both displayed, it is preferred that they are displayed adjacent to or near one another, for example in different windows on the same computer screen. Preferably, the graphical representation and the scanned images are two different renderings of the same anatomy. Thus, movement of the control device causes a corresponding movement in both versions of the viewed anatomy.

It is preferred that the training system further comprises an assessment component. This can be realised by the system including means for electronically recording aspects of the users interaction with the system enabling an assessment or measure of the users performance to be made. This may be referred to as a ‘learning management system’ (LMS). Preferably, the LMS is configured to provide an assessment of the student's performance of tasks based on the manipulation of the control device. Preferably the LMS comprises a plurality of further components, such as a user interface. The LMS may comprise a security and/or access control component. For example, the student may be required to log into the LMS or undergo some type of authentication process.

It is preferred that the LMS provides training related content to the user before during and/or after use of the training system. This training content may include instructions regarding the type or nature of task to be accomplished, and/or how to accomplish it. The content may be provided in a variety of formats. For example, it may be presented as text or in an audible form.

In an alternative embodiment, the LMS may ‘remember’ data relating to the user's previous interactions with the system and may present these to the user for feedback, teaching and/or motivational purposes.

In accordance with a second aspect of the present invention, there is provided at least one pre-determined metric or performance-related criterion. Preferably, a plurality of metrics is provided wherein each criterion serves as a benchmark or gauge against which an aspect of the student's performance may be measured. The comparison of the student's performance against the metrics may be performed by a metric analysis component of the system.

It is preferred that the metrics are stored in a simulator definition file. Preferably, a simulator definition file (and set of metrics contained therein) is provided for each assignment or pedagogical objective that the student may undertake. Thus, the metrics are task-oriented and enable the student's performance to be assessed in comparison with the performance expected of a competent or expert user, or with standards set down by a professional body. In addition to the results themselves, it is preferred that the simulator definition file contains text relating to each metric. This text may provide a recommendation as to whether the student has succeeded or failed in achieving the particular learning objective. In an alternative embodiment, multiple metrics may be assessed in combination to provide enhanced analysis based on the assessment of multiple criteria.

It is preferred that throughout a given training session, data pertaining to the student's use of the control device is noted. Preferably, this data is recorded within an audit trail. Preferably, the position, orientation and applied force of the probe are recorded at spaced or timed intervals. Preferably, the student's performance data are analysed in view of the metrics at the end of the simulation session. Thus, the results which have been accrued in the audit trail file during the training session are received as input by the metrics analyser. However, the skilled addressee will understand that the metrics comparison may also be performed at any time during the learning session.

The metric criteria may be determined in a number of ways. For example, it may be determined empirically, or by assessing the performance of at least one expert using the invention, or from known medical knowledge

In accordance with one aspect of the present invention the ultrasound scan view image is a composite image generated from merging data obtained from different sources. The sources may be 2 dimensional scans obtained by scanning a volunteer subject's body using a conventional ultrasound machine. Effectively a 3-D ultrasound volume is provided for use with an ultrasound training system, the 3-D ultrasound volume comprising a composite volume in which one portion has been imported into the 3-D volume from at least one other volume, or separate volumes combined. This is achieved by merging the electronic data of the scan view and/or the graphical anatomy representation from a number of different sources, volunteers or subjects.

The 3-D volume may be created as a composite of real volunteer subjects' anatomies. One or more selected portions of a scan of a real volunteer subject's anatomy may be copied and superimposed (or ‘pasted’) onto the corresponding area of the virtual volume. The selected portion may be an area corresponding to, for example, a the subjects ovaries or other internal organ. Thus, a new, virtual volume may be built up as a mosaic of scanned data originally derived from more than one volunteer subject. For example, it may be decided that, for pedagogical reasons, a particular volume would be preferred with larger ovaries than those possessed by the actual subject. Thus, the present invention provides such a tailored virtual volume.

The 3-D volume is created by converting 2-Dimensional ultrasound scans or images into a 3-Dimensional volume by creating a 3-D grid of voxels from a stream of 2-D grids of pixels. Thus, a 3D anatomical volume may be created from a ‘sweep’ of a 2-D ultrasound image. As a single sweep may not cover the full area required for the image (because the beam width may not be wide enough), multiple ‘sweeps’ may be performed wherein each ‘sweep’ may record a video of consecutive 2-D images with respect to time. Multiple sweeps may then be merged to build up a larger dataset pertaining to the 2-D ultrasound scanned image. This may be needed because one sweep cannot cover the full area of interest required for the simulator due to 2-D ultrasound beam limitations.

It is preferred that, having compiled a collection of ‘sweeps’ from the scanned 2-D data, the sweeps are alpha blended together. This is preferably performed using a mask, the mask defining which pixels in the sweeps are to be ignored and/or which are to be used as input into the resulting 3-D volume.

In a preferred embodiment, the resulting alpha blend may then be edited to import data from one or more alternative datasets, such that desired portions of that other data set are incorporated into the alpha blend to create a 3-D volume having the desired anatomical attributes. Thus, the resulting virtual volume is a representation of a portion of a virtual patient's body designed in accordance with pedagogical motivations.

This provides the advantage that additional virtual volumes can be created quickly and easily. In addition, this provides the advantage that students can be exposed to a greater variety of anatomies and structures in less time than would be possible if he/she were training by clinical practice alone.

Alternatively, the 3-D volume may comprise an artificially generated dataset designed to represent a specific subject anatomy.

Furthermore, the dataset maybe processed in such a way or to vary with time or force applied via the control input device in order to mimic movement of the subject such as fetal heartbeat, baby in womb movement, or spatial relationship changes induced by the force applied by the input control device.

Thus, the present invention eliminates or alleviates at least some of the drawbacks of the current ultrasound training environment whilst providing the advantages outlined above.

These and other aspects of the present invention will be apparent from, and elucidated with reference to an exemplary embodiment of the invention as described herein.

An embodiment of the invention will now be described by way of example only and with reference to the accompanying drawings.

### BRIEF DESCRIPTION OF THE DRAWINGS

FIG. 1 shows the components and events of an embodiment of the present invention.

FIG. 2 shows a typical view of a simulation based ultrasound training session presented to a student in accordance with an embodiment of the present invention.

FIG. 3 shows a user interacting with a system in accordance with the present invention.

### DETAILED DESCRIPTION OF THE PREFERRED EMBODIMENTS

The following exemplary embodiment describes the invention's use in relation to transvaginal scanning However, this application is for illustrative purposes only and the invention is not intended to be limited in this regard. Other embodiments may be applied to other types of medical use;

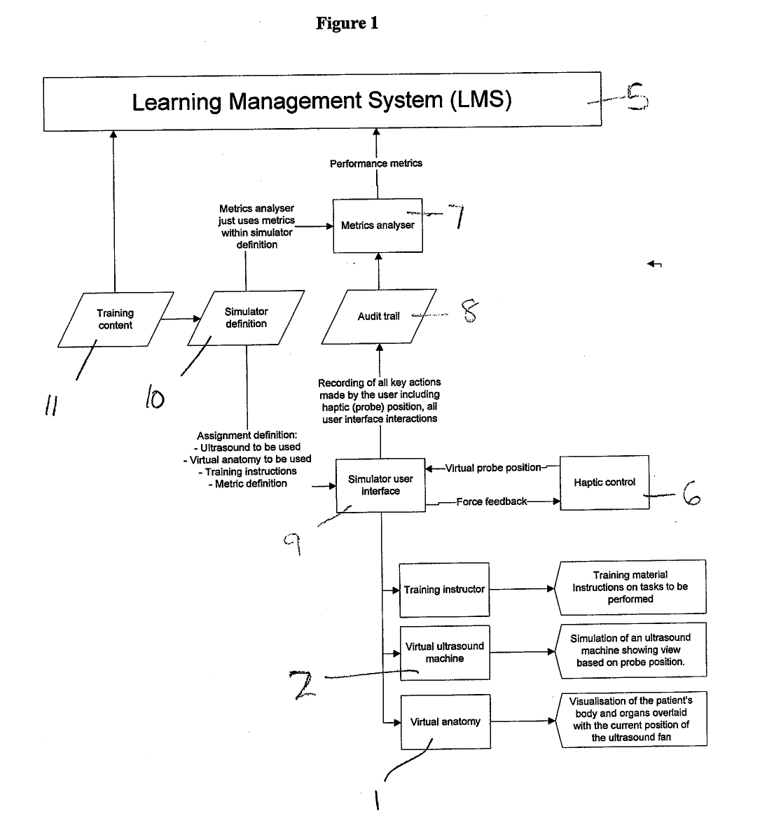

Turning to FIG. 1, a medical ultrasound training simulator is provided and comprises the following components:
Learning Management System (LMS) 5 which oversees or manages the learning experience presented to the user;
User assessment component 7. This enables a judgment or analysis of the user's performance to be formed.
Ultrasound simulation component 2 configured to replicate the key features of a conventional ultrasound machine. This may be referred to as the ‘virtual ultrasound machine’.
Replica ‘intelligent’ ultrasound probe 6 as an input device to be manipulated by the user and provide electronic input into the system. The input device 6 may be, for example a haptic device in communication with the simulator component of the system.
Computer and other associated hardware for running the software components of the invention
High resolution screen 13 for displaying and presenting information to the user 12. This may be a touch screen.

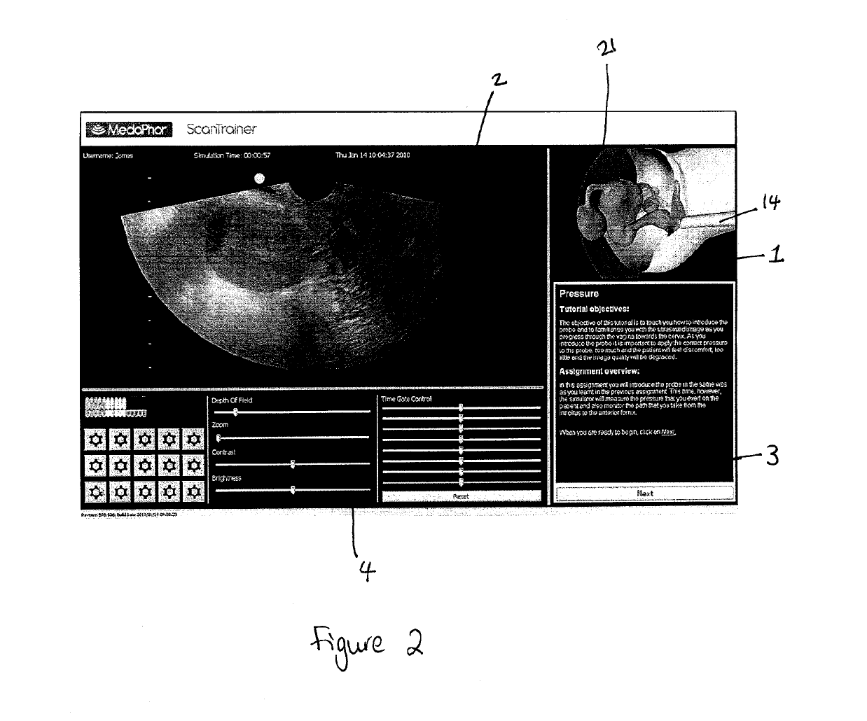

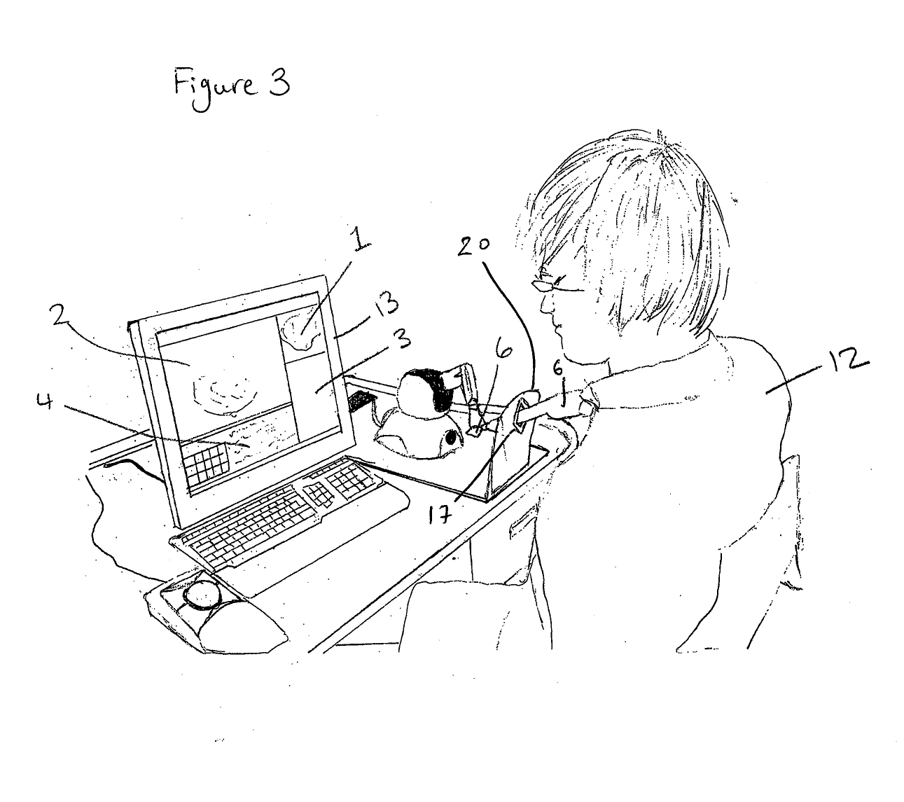

With reference additionally to FIGS. 2 and 3, in use a user 12 logs into the LMS 5 of the ultrasound training system to begin a training session. This may require authentication via a variety of known methods (e.g. by providing a user ID and password). The interaction between the user and the system components is handled via a user interface, which may be written in any appropriate programming language.

After logging into the system, the LMS 5 provides the user with an overview of the course content 3. This overview presents the student with information regarding the objectives and learning outcomes of the modules. Each module is divided into a number of tutorials and assignments. A tutorial relates to themes of a particular technique such as orientation conventions or introduction of the transvaginal probe, whilst an assignment is a group of tasks within a module which constitute a key learning point (such as the orientation in sagittal and coronal planes or direction and positioning and pressure for the latter).

The user then selects which training modules (s)he wishes to undertake (e.g. examination of the normal female pelvis, normal early pregnancy or assessment of fetal well being). When the user indicates that (s)he wishes to undertake an assignment, (i.e. run the simulator), the LMS 5 provides initial instructions to the student. The instructions may be provided orally or visually. The LMS also passes a simulator definition 10 to the simulation component so that the assignment can be performed.

The simulator definition 10 is a package of information and data pertaining to a particular assignment for testing and training a student with regard to a particular objective or task. For example, the simulator definition 10 may include a full description of the relevant assignment, including text to be displayed, parameters relating to the ultrasound volume to be used, which volume is to be used, which force feedback files should be used and a full description of the metrics to be tested. Associated pass/fail criteria may also be included. The training content 11 is stored within XML files, thus enabling the training content 11 to be configured, updated and altered.

The user may be offered the option of using the simulator in ‘practice mode’ without feedback or an ‘interactive mode’ whereby the user follows instructions to under-take specific tasks which will then be measured against a set of ‘gold standard’ metrics. These instructions may be provided in textual form e.g. on screen or in audible form e.g. via a speaker.

Thus, when the user selects an assignment via the LMS interface, the appropriate simulator definition 10 is loaded in the simulator 7 and the training session begins. During the training session, the user completes the selected assignment or task by manipulating the haptic input device 6 (i.e. ‘intelligent probe’). The user operates the physical input device 6 to navigate a virtual ultrasound probe 14 around a virtual patient's anatomy. This may appear on the screen 1 as a recreated ultrasound scan view image 2 and/or as a simulated ultrasound beam corresponding to the plane and movement of the virtual probe 14. As the intelligent replica probe 6 is moved, the display 1 shows the progress of the beam in the simulation of the patient's anatomy.

Thus, by using the haptic input device 6, the training system allows the user 12 to perform ultrasound operations in a virtual world which mimics how the operation would be performed in a clinical session on a living patient. For example, the user is able to perform operations such as examining and measuring the virtual patient's internal organs.

During the session, the system shows the ultrasound volume and the virtual anatomy in two side-by-side views which are shown in separate windows on the user's screen, as shown in FIG. 2:
1. a recreated ultrasound scan view image generated during real-time scanning 2. Thus, the virtual ultrasound machine 2 enables presentation of a simulated ultrasound machine showing a scan view image based on the probe input device's current position. This is shown in screen 2 of FIG. 2. As the user moves the haptic input device, the perspective of the scan view image 2 is changed accordingly, as would occur if the user was operating a ‘real’ ultrasound machine.
2. a view of the progress of the simulated scanning beam 21 in the anatomy of the virtual patient 1. Screen 1 of FIG. 2 shows such a graphical representation of the anatomy as created by a graphic artist (this process is discussed in more detail below). The graphical representation of the anatomy is shown from the perspective of the virtual probe 14. The virtual probe and its orientation are shown, along with the scan plane 21 resulting from the position of the virtual probe 14. A ‘slice through’ of the anatomy is shown based on the plane 21 of the virtual probe 14. As the user moves the haptic device, the virtual probe 14 mirrors the movement and is seen to move on the screen 2. Accordingly, the viewed perspective of the anatomy is altered (e.g. rotated) so as to reflect the change in the simulated scan plane 21.

The two images (i.e. the simulated scan view image in screen 2 and the graphical representation in screen 1) both track the movement of the haptic input 6 device so that as the user performs the required learning tasks, (s)he is able to see the results of her/his actions in two forms or representations. This provides an enhanced understanding of the results of manual actions.

While both of the views described above may be presented to the user at the same time, the skilled addressee will appreciate that in some embodiments only one of the above images may be displayed. In other words, the system may display only the ultrasound volume or the graphical representation of the virtual anatomy.

A third window 3 may also be presented to the user during the training session, containing instructions and/or information regarding the selected training module. Alternatively, these instructions and/or information may be provided in an audible form rather than via the screen. Thus, the screen may provide the user with one or both of the anatomical views described above, with or without an additional third screen for presentation of training-related material.

The interaction between the user and the simulator 2 is managed by an interface 9 which enables data to be obtained from the haptic input device 6 (e.g. position within the virtual anatomy) and fed back to the haptic input device (i.e. force feedback). Thus, the haptic device 6 provides feedback to the user regarding the force (s)he is applying via the probe and the resistance which the tissue or other matter is providing.

In some embodiments, a hardware constraint such as an aperture 17 of defined perimeter in a support frame 20 may be used to limit the movement of the haptic input probe 6 thus replicating the range of movement of a real probe, which would be inhibited by the patient's body. The system may also artificially constrain the exit point of the probe from the virtual body opening e.g. mouth, vagina or anus or an operative entry point e.g. laparoscopic port such that it is at the correct point in the virtual anatomy. This avoids an incorrect visualisation in the event of a mismatch in the measurement of the probe position or angle. For example, in such an event the probe may otherwise exit incorrectly through the virtual anatomy's leg or other body part. However, other embodiments of the system may not require the use of a hardware constraint.

Thus, a sophisticated level of interaction is provided with the system which mimics the experience obtained in a clinical training session. The user is provided with a realistic sensation of a scanning operation, both through pressure when pushing against organs and by preventing the probe from moving to anatomically impossible positions.

During the simulation, the known techniques are used to deform the virtual anatomy to simulate the effect of the probe e.g. within a cavity such as the vaginal canal or on the external surface of the body. Other techniques are also used to simulate some of the key functionality of an ultrasound machine, thus enhancing the realism of the student's experience. These may be presented and controlled by the student during the training session via an area of the screen 4. These features may include including:
Brightness, contrast and Time Gain Compensation (TGC) controls
Image annotation (labelling and text annotation)
Changing image orientation
Freeze and split screen functionality
Magnify and zoom image
Take pictures or make video recordings
Take measurements of a distance or an area or calculate a volume from a series of measurements

Via the LMS 5, the student is also able to view saved screenshots and/or video recordings of his performance.

Throughout the training session, user interaction and session data are stored or recorded by the system within an audit trail 8. Additionally, the haptic position and/or orientation, and applied force, are recorded at spaced or timed intervals (e.g. every 100 ms). At the end of the simulation, this information is analysed to determine the user's performance in respect of the relevant metrics.

The user's performance is assessed by use of the metric analysis component 7. Whilst the analysis may be performed at any time during the session, it will more typically take place as a batch operation at the end of the simulation run (i.e. the assignment) using the results stored in the audit trail file 8.

The metric analyser 7 compares the data obtained during the simulation regarding the student's performance against a set of pre-determined criteria stored in the simulator definition file 10 for the selected assignment (i.e. the ‘metrics’). Metrics are associated with each task within an assignment and enable assessment of the student's performance of that task against key performance criteria. For example, if the task is to fully examine and measure the size of the patient's right ovary, the metrics may check the maximum force applied by the simulated probe, the time taken to complete the examination, the probe movement profile, the measurements taken e.g. length, width and height of the ovary and the measurements position.

Comparison is made against a number of different metrics, each of which measures a single aspect of the student's performance. The following metrics may be included in the system although the following list is not intended to be finite or absolute:

| | |
|---|---|
| Time | Time taken to perform the task |
| FlightPath | How closely the student followed the ‘expert’ |
| | probe path. |
| | The algorithm used is as follows: |
| | For each expert probe (haptic) position recorded |
| | find the closest student point by absolute distance |
| | (C) |
| | Metrics are min (C), max (C), mean (C) |
| LocatePlane | Checks position of a frozen ultrasound view |
| | compared to that recorded by the expert. |
| AngularDeviation | Checks the deviation from a specific orientation |
| | vector made by the student during a scan |
| MultipleChoice | Multiple choice questions |
| Force | Maximum force applied |
| Contrast | Checks screen contrast against limits |
| Brightness | Checks screen brightness against limits |
| TGC (Time Gain | Checks TGC against limits |
| Compensation) | |
| UltraSound | Checks ultrasound orientation (ie orientation of |
| Orientation | ultrasound image which can be flipped or rotated |
| | on the user interface) |
| Label | Checks the position of an annotation label |
| 1dMeasurement | Checks value and position of a 1d measurement |
| | in the ultrasound view |
| 2dMeasurement | Checks value, position and perpendicularity of |
| | two 1d measurements in the ultrasound view |
| 3dMeasurement | Checks value, position and perpendicularity of |
| | three 1d measurements in the ultrasound view |
| VerifyArrow | Checks the orientation of an arrow drawn on the |
| | screen against the expert's arrow |

It should be noted that the above examples of metrics are provided by way of an example only. The skilled addressee will understand that the system may be adapted so as to be used for other types of ultrasound applications and, therefore, a different set of metrics may be drawn up which relate more closely to that particular type of operation.

The metric criteria may be determined in a number of ways:
Empirically (e.g. it may determined that a student must take less than 30 s for a particular task)
By assessing the performance of a number of experts using the simulator (e.g. by using the simulator itself to find the average probe path followed by an expert).
From medical knowledge (e.g. doctors and practitioners may supply a specified maximum force limit because this is the level which, in their experience, causes patient discomfort).

In addition to the results themselves, the simulator definition file 10 also contains specific text for each metric giving a recommendation with regard to whether the user has passed or failed that particular aspect of the assignment. Alternatively, multiple metrics may be assessed as a combination to provide improved guidance based on multiple criteria.

When the user has completed the assignment, (s)he returns to the LMS interface 5 so that her/his results may be reviewed and assessed. The user may then re-take the assignment if the feedback indicates that the performance was not satisfactory in comparison to what is expected by the metrics, or may progress to the next assignment.

Additionally, for users who are enrolled in a specific training programme, the user's supervisor may have access rights to the user's reports on the LMS 5, thus enabling the supervisor to monitor progress and performance on an ongoing basis.

Prior to use, at least one (but typically more than one) 3-D ultrasound volume of an anatomy is created for use with the training system.

In order to create the required volume, a 2D ultrasound scan view image is captured using a ‘conventional’ ultrasound machine. The captured 2D ultrasound may be stored inside the ultrasound machine itself or on a DVD for subsequent use and replay.

As a 3-D ultrasound volume is used with the present invention, the 2D ultrasound image must be converted or transformed into the requisite 3-D format. Thus, tracked sensor data relating to position and orientation must be combined with the 2-D ultrasound scan. This process requires spatial and temporal calibration of the tracking apparatus.

An example of such calibration techniques will now be discussed as performed during construction of an exemplary embodiment of the present invention.

1. Spatial Calibration

Two tracked magnetic sensors were used to achieve the spatial calibration. One sensor was attached to the ultrasound probe, the other being left “loose”. The probe was suspended in a container of water (to transport the ultrasound), whilst the other probe was intersected into the ultrasound beam.

The positions of both sensors were recorded, along with the orientation of the ultrasound probe sensor. The “loose” sensor was positioned such that the tracked centre of the sensor was in the ultrasound beam, thus producing a sparkle or discernible entity within the ultrasound image. The image was recorded, and the position noted. This was carried out many times to provide a good sample range (e.g. >20).

The 3D position of the “loose” sensor was then mapped to the sensor connected to the ultrasound probe. This enabled the calculation of where ultrasound pixels in the image were actually located in space, because the position of the target (i.e. tracked sensor) was known.

2. Temporal Calibration

During the temporal calibration, two tracked sensors were used. One sensor was strapped to the ultrasound probe, and the other attached to a nearby wooden pole (to hold it steady). The operator tapped the wooden pole with the ultrasound probe. As a result, the wooden pole becomes instantly visible in the ultrasound image whilst the second sensor registered the sudden movement. This was carried out at the start and end of a scan, to calibrate and demark the start and stop of the scan in both movement and ultrasound imagery. The movement in the 2^{nd} sensor was more pronounced than the movement in the 1^{st} sensor, and the 2^{nd} sensor was usually stationary (until it was tapped) making it easier to find in the stream of position and orientation data.

3. Volume Generation

Given the spatial and temporal calibration, the 2D ultrasound image could be accurately “Swept” in 3D. Thus, it was possible to ‘paint’ using a 2D ultrasound video as a paintbrush.

A volume conversion utility was used to paint the 2D ultrasound images into a 3D volume, the volume being a 3D grid of voxels created from a stream of 2D grids of pixels. This enabled a single “sweep” to create a 3D volume of ultrasound.

Multiple “sweeps” were then merged to build up a larger dataset. These were then alpha blended by creating a “mask” which defined which pixels were to be ignored and which pixels were to be used in the input ultrasound image, enabling blends to be achieved between images. The correct blend was then calculated manually to minutely adjust the 2^{nd} (or subsequent) sweep(s) to align them correctly, or at least minimise (visible) overlap error.

The alpha blends were then used to merge in data from an alternative dataset, enabling the creation of a new 3-D ultrasound volume by merging volunteer subject data. For example, small ovaries in a dataset can be replaced with larger ovaries from a different volunteer subject. Although the result was the product of two different bodies being merged, the result appears sufficiently accurate to the eye. Thus, multiple virtual patients may be created from a base collection of virtual volunteer subjects.

In addition, a 3-Dimensional anatomical graphical representation of a volume was created by segmenting out the organs of interest (e.g. the ovaries) from ‘real’ ultrasound volumes. These were sent to a graphic artist for transformation into an anatomical graphical representation. The anatomical graphical representation may then be manipulated on the screen during the training session as described above. Screen 1 of FIG. 2 shows an example of such a graphical representation in accordance with an embodiment of the invention, and shows the simulated probe and associated scanning plane, and the virtual anatomy from the perspective of the scanning plane. The ultrasound scan view image and the anatomical graphical image are linked to vary in a matched relationship as the input device 6 is manipulated.

The invention has been primarily described in an embodiment in which scan data is obtained from ultrasound scans conducted on ‘real’ subjects. It should be appreciated that, alternatively, virtual datasets may be created artificially through forward simulation or by other methods. Such artificial data maybe merged with real data, in certain embodiments, where preferred.

Furthermore, the data may be processed or manipulated to provide variations in time or in response to a force applied by the input device. Such manipulation may, for example, enable the scan view image to vary to represent fetal heartbeat, baby in womb movement, or changes to the shape of physical area under investigation as a result of the application of force to the baby via the input device.

Thus, the present invention provides the advantage of teaching key skills to the student whilst providing real-time feedback on performance and charting a path for the student to achieve full competence. Other advantages arise from the present invention as follows:
Provision of non-clinical learning environment, thus solving the current resource conflict between provision of clinical service and need to train, releasing expensive ultrasound equipment for clinical use;
Assist in overcoming the current shortages of suitably qualified trainers as well as learning capacity in hospitals and training centres;
Improvement of the quality and breadth of ultrasound learning prior to the trainee's exposure to patients;
Provides the trainee with accurate feedback ‘active learning’, monitoring performance and providing structure to the training process;
Eliminates the need for an expert's direct supervision, thus providing a highly cost-effective solution;
Enables the student to experience a wider variety of anatomies in a more condensed period of time than would be possible during clinically-based training;
The learning modules and/or metrics can be developed in accordance with industry curriculum so as to meet the learning objectives set out by professional bodies, thus meeting professional gold standards;
Provides an effective and reproducible training programme.

1. A simulator training system for simulation training in ultrasound examination or ultrasound-guided procedures, the simulator training system comprising:
a simulator input device to be operated by the user, the input device being movable;
means for displaying an ultrasound scan view image, being an image or facsimile image of an ultrasound scan, the scan view image being variable and related to the position and/or orientation of the simulator input device; and
means for displaying a second image, the second image being an anatomical graphical representation of a slice through of the body structure associated with the ultrasound scan view, the second image indicating the scan beam plane of the simulator input device;
wherein the ultrasound scan view image and the second image are linked to vary in a coordinated manner as the position and/or orientation of the simulator input device changes.

2. A simulator training system according to claim 1, further comprising:
a simulator input device constraint arrangement to provide one of a constraint on the positional movement of the simulator input device and a context for the required scan.

3. A simulator training system according to claim 1, wherein:
a) the system further includes means for electronically recording aspects of the users interaction with the system enabling an assessment or measure of the users performance to be made; and/or
b) the ultrasound scan view image is a composite image composed of scan view image data obtained from different sources and merged; and/or,
c) the ultrasound scan view image is generated from a scan volume, the scan volume being a 3-Dimensional (3-D) scan volume created by converting 2-Dimensional ultrasound scans or images to form the 3-Dimensional scan volume.

4. A simulator training system according to claim 3, wherein:
the scan view image data is obtained from scan data from different volunteers or subjects which are selected and merged.

5. A simulator training system according to claim 4, wherein:
the second image is a 3-Dimensional anatomical graphical representation of a volume created from the scan view image by segmenting out the organs of interest from the scan view image and rendering as a graphical representation of the segmented out organs.

6. A simulator training system according to claim 1, wherein:
the simulator input device is arranged to provide a force feedback to the user under output control from the system, in defined circumstances.

7. A simulator training system according to claim 6, wherein:
the simulator input device comprises a haptic device having an electronic transducer onboard operating in response to system output.

8. A simulator training system according to claim 1, further comprising:
an assessment component enabling electronically recording of metrics related to the user's interaction with the system enabling an assessment or measure of the user's performance to be made.

9. A simulator training system according to claim 8, wherein:
metrics relating the user's manipulation of the input device in respect of specific tasks as compared to a standard or baseline result, in order to assess the user's performance.

10. A simulator training system according to claim 8, further comprising:
a metrics analyser.

11. A simulator training system according to claim 10, wherein:
metrics are stored in a simulator definition file of the system.

12. A simulator training system according to claim 1, wherein:
a virtual control device is displayed in real time to the user, which mimics the movement and orientation of the simulator input device.

13. A simulator training system according to claim 1, further comprising:
a virtual ultrasound machine configured to simulate an ultrasound machine.

14. A simulator training system according to claim 1, further comprising:
means for processing scan volume data in order to represent time varying changes to the anatomy or change to the anatomy as a result of force applied via the input device.

15. A virtual anatomy in electronic form, for use with an ultrasound simulation system, the virtual anatomy being generated artificially, and the virtual anatomy comprising a composite anatomy, wherein the composite anatomy has at least one of the following features:
i) being merged from one or more separate anatomies; and
ii) including at least one portion imported from at least one other anatomy.

16. A virtual anatomy according to claim 15, wherein:
the merged anatomies comprise electronic data recorded from real volunteer scans.

17. A method of creating a virtual scan volume for use with an ultrasound training system, the method comprising:
i) creating a first ultrasound volume by repeatedly converting a plurality of 2-Dimensional ultrasound images into a 3-Dimensional ultrasound volume to obtain a plurality of 3-Dimensional ultrasound volumes, and merging the plurality of 3-Dimensional ultrasound volumes;
ii) selecting a portion of a second ultrasound volume; and
iii) importing the selected portion of the second volume into the first ultrasound volume.

18. A method according to claim 17, wherein:
the first and second volumes are obtained from ultrasound scans of different sources or subjects.

19. A method of creating a 3-Dimensional (3-D) virtual scan volume for use in an ultrasound simulator system, the method comprising converting a multiplicity of 2-Dimensional ultrasound scans or images to form the 3-Dimensional scan volume.

20. A method according to claim 19, wherein:
the 2-D scans are manipulated by a conversion utility to paint the 2D ultrasound images into a 3D volume, the volume being a 3D grid of voxels created from a stream of 2D grids of pixels.

21. A method according to claim 19, wherein:
the 2-D scans are merged to build up a larger dataset, the larger dataset being alpha blended by creating a mask defining which pixels are to be ignored and which pixels are to be used in the 3-D virtual scan volume.

22. A simulator training system for simulation training in ultrasound examination or ultrasound-guided procedures, the simulator training system comprising:
a simulator input device to be operated by the user, the input device being movable;
means for displaying an ultrasound scan view image, being an image or facsimile image of an ultrasound scan, the scan view image being variable and related to the position and/or orientation of the simulator input device; and
a simulator input device constraint arrangement to provide at least one of a constraint on the positional movement of the input device and a context for the required scan.

23. A simulator training system according to claim 22, wherein:
a) the system further includes means for electronically recording aspects of the users interaction with the system enabling an assessment or measure of the users performance to be made; and/or
b) the ultrasound scan view image is a composite image composed of scan view image data obtained from different sources and merged; and/or
c) the ultrasound scan view image is generated from a scan volume, the scan volume being a 3-Dimensional (3-D) scan volume created by converting 2-Dimensional ultrasound scans or images to form the 3-Dimensional scan volume.
